(19) United States
(12) Patent Application Publication
(10) Pub. No.: US 2021/0012787 A1
(43) Pub. Date: Jan. 14, 2021

(54) DETECTION AND RESTORATION OF DISTORTED SIGNALS OF BLOCKED MICROPHONES

(71) Applicant: QUALCOMM Incorporated, San Diego, CA (US)

(72) Inventors: Sanghyun Chi, San Diego, CA (US); Shankar Thagadur Shivappa, San Diego, CA (US); Nils Gunther Peters, San Diego, CA (US); S M Akramus Salehin, San Diego, CA (US)

(21) Appl. No.: 16/507,428

(22) Filed: Jul. 10, 2019

(51) Int. Cl. G10L 21/0216; H04R 3/00; G10L 21/0264

(52) U.S. Cl. CPC G10L 21/0216; G10L 2021/02087; G10L 21/0264; H04R 3/005

(57) ABSTRACT

Methods, systems, and devices for mitigating audio interference are described. The methods, systems, and devices may relate to monitoring a parameter associated with an audio signal received by at least a first microphone of multiple microphones of a device, determining that the monitored parameter associated with the audio signal exceeds a threshold by comparing the monitored parameter to the threshold, determining an acoustic path interference associated with the monitored parameter based on the monitored parameter exceeding the threshold, the acoustic path interference including a physical interference in an acoustic path to at least the first microphone, and implementing a restoration process to mitigate the acoustic path interference based on determining the acoustic path interference associated with the monitored parameter.

### BACKGROUND

The following relates generally to mitigating audio interference, and more specifically to detection and restoration of distorted signals of one or more blocked microphones.

Audio and sound detected by microphones (e.g., speech, music, etc.) may experience interference, including but not limited to physical interference (e.g., from user hands, user fingers, physical objects in the environment, etc.). By way of example, a user may use an audio recording device to capture sound from a certain environment. The user may, in some examples, inadvertently cover or at least partially block a microphone of the recording device, causing interference in the captured audio.

### SUMMARY

The described techniques relate to improved methods, systems, devices, and apparatuses that support detection and restoration of distorted signals of one or more blocked microphones. Generally, the described techniques provide for detecting acoustic path interference in an acoustic path between an audio source and a microphone, resulting in an audio signal of the microphone being distorted. The techniques include mitigating the acoustic path interference by calculating one or more restoration parameters and applying corrective action related to the one or more restoration parameters to the distorted audio signal to enhance audio directivity, among other aspects, during a recording process (e.g., during ambisonic capture associated with two or more microphones).

A method of mitigating audio interference is described. The method may include monitoring a parameter associated with an audio signal received by at least a first microphone of multiple microphones of a device, determining that the monitored parameter associated with the audio signal exceeds a threshold by comparing the monitored parameter to the threshold, determining an acoustic path interference associated with the monitored parameter based on the monitored parameter exceeding the threshold, the acoustic path interference including a physical interference in an acoustic path to at least the first microphone, and implementing a restoration process to mitigate the acoustic path interference based on determining the acoustic path interference associated with the monitored parameter.

An apparatus for mitigating audio interference is described. The apparatus may include a processor, memory coupled with the processor, and instructions stored in the memory. The instructions may be executable by the processor to cause the apparatus to monitor a parameter associated with an audio signal received by at least a first microphone of multiple microphones of a device, determine that the monitored parameter associated with the audio signal exceeds a threshold by comparing the monitored parameter to the threshold, determine an acoustic path interference associated with the monitored parameter based on the monitored parameter exceeding the threshold, the acoustic path interference including a physical interference in an acoustic path to at least the first microphone, and implement a restoration process to mitigate the acoustic path interference based on determining the acoustic path interference associated with the monitored parameter.

Another apparatus for mitigating audio interference is described. The apparatus may include means for monitoring a parameter associated with an audio signal received by at least a first microphone of multiple microphones of a device, determining that the monitored parameter associated with the audio signal exceeds a threshold by comparing the monitored parameter to the threshold, determining an acoustic path interference associated with the monitored parameter based on the monitored parameter exceeding the threshold, the acoustic path interference including a physical interference in an acoustic path to at least the first microphone, and implementing a restoration process to mitigate the acoustic path interference based on determining the acoustic path interference associated with the monitored parameter.

A non-transitory computer-readable medium storing code for mitigating audio interference is described. The code may include instructions executable by a processor to monitor a parameter associated with an audio signal received by at least a first microphone of multiple microphones of a device, determine that the monitored parameter associated with the audio signal exceeds a threshold by comparing the monitored parameter to the threshold, determine an acoustic path interference associated with the monitored parameter based on the monitored parameter exceeding the threshold, the acoustic path interference including a physical interference in an acoustic path to at least the first microphone, and implement a restoration process to mitigate the acoustic path interference based on determining the acoustic path interference associated with the monitored parameter.

Some examples of the method, apparatuses, and non-transitory computer-readable medium described herein may further include operations, features, means, or instructions for capturing, as part of an ambisonic audio capture based on implementing the restoration process, the audio signal from the first microphone and at least an audio signal of a second microphone from the multiple microphones.

In some examples of the method, apparatuses, and non-transitory computer-readable medium described herein, determining that the monitored parameter associated with the audio signal exceeds the threshold may include operations, features, means, or instructions for determining that a frequency power ratio associated with the audio signal exceeds a frequency threshold.

Some examples of the method, apparatuses, and non-transitory computer-readable medium described herein may further include operations, features, means, or instructions for calculating a restoration gain based on a variation between the frequency power ratio and a second frequency power ratio that may be defined during a calibration process, where the restoration process may be based on the restoration gain.

In some examples of the method, apparatuses, and non-transitory computer-readable medium described herein, implementing the restoration process may include operations, features, means, or instructions for applying the restoration gain to the audio signal, or suppressing the audio signal and applying the restoration gain to an audio signal of a second microphone of the multiple microphones to mitigate the acoustic path interference, where the frequency power ratio may be a ratio between measured power levels of the audio signal of the first microphone and measured power levels of an audio signal of a second microphone of the multiple microphones.

In some examples of the method, apparatuses, and non-transitory computer-readable medium described herein, determining that the monitored parameter associated with the audio signal exceeds the threshold may include operations, features, means, or instructions for determining that a pilot signal power ratio associated with the audio signal exceeds a pilot signal threshold.

Some examples of the method, apparatuses, and non-transitory computer-readable medium described herein may further include operations, features, means, or instructions for calculating a restoration gain based on a variation between the pilot signal power ratio and a pilot signal power ratio that may be defined during a calibration process, where the restoration process may be based on the restoration gain.

In some examples of the method, apparatuses, and non-transitory computer-readable medium described herein, implementing the restoration process may include operations, features, means, or instructions for applying the restoration gain to the audio signal, suppressing the audio signal and applying the restoration gain to an audio signal of a second microphone of the multiple microphones to mitigate the acoustic path interference, where the pilot signal power ratio may be a ratio between measured power levels of the audio signal of the first microphone and measured power levels of an audio signal of a second microphone of the multiple microphones.

In some examples of the method, apparatuses, and non-transitory computer-readable medium described herein, implementing the restoration process may include operations, features, means, or instructions for switching from a first calibration configuration to a second calibration configuration, where the first calibration configuration may be tuned to be used with the audio signal of the first microphone and an audio signal from a second microphone from the multiple microphones, and where the second calibration configuration may be tuned to be used with one of the audio signal of the second microphone or the audio signal of the first microphone.

Some examples of the method, apparatuses, and non-transitory computer-readable medium described herein may further include operations, features, means, or instructions for determining a calibrated frequency coloration associated with the first microphone during a calibration process, and detecting a distorted frequency coloration in the audio signal of the first microphone based on determining the acoustic path interference, where implementing the restoration process may be based on mitigating the distorted frequency coloration.

In some examples of the method, apparatuses, and non-transitory computer-readable medium described herein, implementing the restoration process may include operations, features, means, or instructions for generating one or more inverse filters based on comparing the distorted frequency coloration and the calibrated frequency coloration, and applying the one or more inverse filters to the audio signal of the first microphone to mitigate the distorted frequency coloration.

In some examples of the method, apparatuses, and non-transitory computer-readable medium described herein, the monitored parameter includes an energy ratio, a frequency rolloff, an impulse response, or a transfer function, or any combination thereof.

Some examples of the method, apparatuses, and non-transitory computer-readable medium described herein may further include operations, features, means, or instructions for generating a notification for a user regarding the determined acoustic path interference, where the notification includes a request that a user of the device initiate the restoration process or a message that the restoration process may be being implemented automatically, and displaying the notification on a display of the device.

Some examples of the method, apparatuses, and non-transitory computer-readable medium described herein may further include operations, features, means, or instructions for receiving a user input to initiate the restoration process in response to the request, where implementing the restoration process may be based on the user input.

In some examples of the method, apparatuses, and non-transitory computer-readable medium described herein, implementing the restoration process may include operations, features, means, or instructions for initiating the restoration process automatically based on determining the acoustic path interference associated with the monitored parameter.

### BRIEF DESCRIPTION OF THE DRAWINGS

FIG. 1 illustrates an example of a system for mitigating audio interference that supports detection and restoration of distorted signals of one or more blocked microphones in accordance with aspects of the present disclosure.

FIG. 2 illustrates an example of a system for mitigating audio interference that supports detection and restoration of distorted signals of one or more blocked microphones in accordance with aspects of the present disclosure.

FIG. 3 illustrates an example of a system for mitigating audio interference that supports detection and restoration of distorted signals of one or more blocked microphones in accordance with aspects of the present disclosure.

FIG. 4 show block diagrams of devices that support detection and restoration of distorted signals of one or more blocked microphones in accordance with aspects of the present disclosure.

FIG. 5 shows a block diagram of an audio manager that supports detection and restoration of distorted signals of one or more blocked microphones in accordance with aspects of the present disclosure.

FIG. 6 shows a diagram of a system including a device that supports detection and restoration of distorted signals of one or more blocked microphones in accordance with aspects of the present disclosure.

FIGS. 7 through 9 show flowcharts illustrating methods that support detection and restoration of distorted signals of one or more blocked microphones in accordance with aspects of the present disclosure.

### DETAILED DESCRIPTION

A device may include multiple microphones (e.g., two or more microphones) to make audio recordings. In some examples, the audio signal related to at least one of the microphones may become distorted such as when a finger or an object is adjacent to, blocks, or covers at least one of the microphones. In some examples, the device with the multiple microphones may be configured to record an ambisonic capture. One example of a device with multiple microphones may be a smart phone device. In some examples, users may hold their smart phone devices while capturing video, where the audio for the captured video is recorded via the multiple microphones. In some examples, a user's hand may inadvertently block or cover at least one of the multiple microphone holes on the smart phone device, resulting in acoustic path interference in the audio recording (e.g., ambisonic capture), which may distort the signal gain and frequency coloration of the recorded audio signals, among other factors. In some examples, acoustic path interference may distort the signal gain of an audio signal captured by the microphone affected by the acoustic path interference. In some examples, different signal gains may degrade a spatial effect in ambisonic capture. In some examples, acoustic path interference may distort a frequency coloration of an audio signal captured by the microphone affected by the acoustic path interference. In some examples, distorted frequency coloration may degrade a spatial effect in ambisonic capture.

The present techniques include detecting acoustic path interference and restoring the resulting distorted audio signals to enhance the directivity during recording (e.g., during ambisonic capture). For example, interference may be detected when a power ratio of low frequency components exceeds a certain threshold (e.g., low frequency power ratio threshold) or when a power ratio of a pilot tone signal exceeds a certain threshold (e.g., pilot tone power ratio threshold). In some examples, an alert or notification may be displayed on the screen of the smart phone device recording the audio indicating corrective action is being implemented or may query a user whether to implement the corrective action. In some examples, the present techniques may include using a graphical user interface to display a signal restoration notification on the screen when an audio signal interference is detected. In some examples, the signal restoration notification may include a method to receive user input to initiate the signal restoration process. In some examples, the signal restoration notification may indicate that a restoration processes automatically has been or is being implemented.

Aspects of the disclosure are initially described in the context of several examples of a system for mitigating audio interference. Aspects of the disclosure are further illustrated by and described with reference to apparatus diagrams, system diagrams, and flowcharts that relate to detection and restoration of distorted signals of one or more blocked microphones.

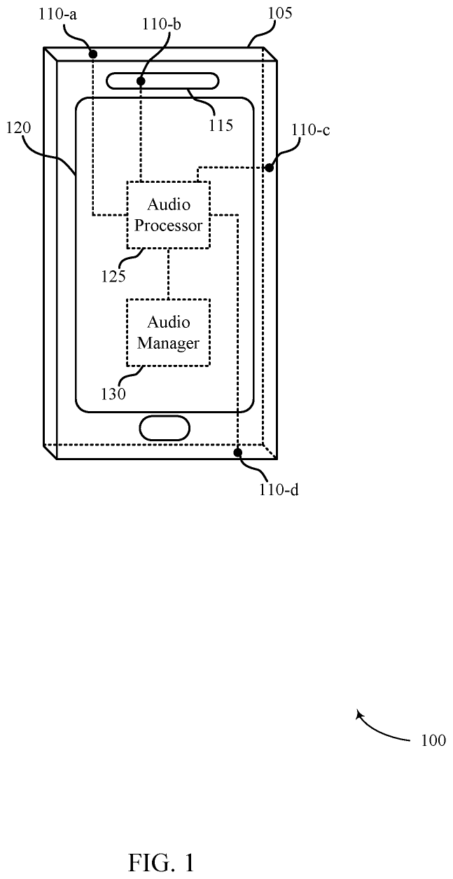

FIG. 1 illustrates an example of a system 100 for mitigating audio interference. In the illustrated example, system 100 includes a device 105. Examples of device 105 may include a smart phone device, a personal digital assistant, a tablet computer, a laptop computer, a desktop computer, a handheld audio recording device, or any combination thereof. As shown, device 105 may include multiple microphones 110 (e.g., top microphone 110-a, front microphone 110-b, side microphone 110-c, bottom microphone 110-d), at least one speaker 115, a screen 120, an audio processor 125 connected to the microphones 110, and an audio manager 130 connected to the audio processor 125. Examples of microphones 110 may include directional microphones, omnidirectional microphones, figure-of-8 or bi-directional microphones, unidirectional microphones, cardioid microphones, hypercardioid microphones, supercardioid microphones, subcardioid microphones, shotgun microphones, or any combination thereof. In some examples, microphones 110 may be configured to detect, generate, or receive audio signals of a sound source in a 3D sound field or 3D space.

In some examples, device 105 may be configured to record an ambisonic capture. Ambisonic capture may include creating, capturing, or playing back spatial audio, or any combination thereof. Ambisonic capture may include capturing a three-dimensional (3D) representation of a sound field. In some examples, ambisonic capture creates a spherical representation of sound where directional information of a recorded sound source is captured in a 3D sound field. Ambisonic capture may include capturing audio on multiple channels or spherical components. In one example, four channels (e.g., channels W, X, Y and Z) may be captured to represent a full 3D sound (e.g., first order ambisonic capture, B-format). In some examples, the four channels may resemble pressure patterns found in an omnidirectional channel (W) and three figure-of-8 microphones to capture, respectively, a left/right channel (Y), a front/back channel (X) and an up/down channel (Z).

In some examples, audio manager 130, in conjunction with audio processor 125, may be configured to monitor audio signals associated with at least one of microphones 110. In some examples, audio manager 130, in conjunction with audio processor 125, may be configured to monitor one or more parameters associated with audio signals from microphones 110. Examples of monitored parameters may include an energy ratio, a frequency rolloff (e.g., variation of energy versus frequency to indicate how the energy of an audio signal varies over different frequencies), an impulse response (e.g., time domain analysis), a transfer function (e.g., frequency domain analysis), a frequency power ratio, a pilot signal power ratio, other parameters, or any combination thereof. In some examples, audio manager 130, in conjunction with audio processor 125, may be configured to determine whether at least one of the monitored parameters associated with the audio signals exceeds a threshold by comparing the monitored parameters to the threshold. In some examples, each monitored parameters may be associated with a respective threshold (e.g., an energy ratio threshold, a frequency rolloff threshold, an impulse response threshold, a transfer function threshold, a frequency power ratio threshold, a pilot signal power ratio threshold). In some examples, each of microphones 110 may be monitored (e.g., simultaneously, concurrently) by audio manager 130, in conjunction with audio processor 125. For example, audio manager 130, in conjunction with audio processor 125, may monitor one or more parameters per microphone 110.

In some examples, audio manager 130, in conjunction with audio processor 125, may be configured to detect an acoustic path interference associated with a monitored parameter of an audio signal associated with microphone 110-a based at least in part on the monitored parameter exceeding the threshold. In some examples, the acoustic path interference may include a physical interference in an acoustic path between the sound source and microphone 110-a. In some examples, audio manager 130, in conjunction with audio processor 125, may be configured to implement a restoration process to mitigate the acoustic path interference of microphone 110-a.

In some examples, audio manager 130, in conjunction with audio processor 125, may detect acoustic path interference in two or more of microphones 110, and may be configured to implement a separate restoration process for each of the affected microphones 110 to mitigate the acoustic path interference in each of the microphones 110 in which acoustic path interference is detected. In some examples, audio manager 130, in conjunction with audio processor 125, may implement a single restoration process to mitigate the acoustic path interference in each of the affected microphones 110.

In some examples, the restoration process may be based at least in part on the determined type of acoustic path interference. For example, audio manager 130, in conjunction with audio processor 125, may implement a first restoration process for a first type of acoustic path interference and implement a second restoration process different from the first restoration process for a second type of acoustic path interference. In one example, audio manager 130, in conjunction with audio processor 125, may implement a first restoration process for a first monitored parameter exceeding a first threshold (e.g., a monitored frequency rolloff exceeding a frequency rolloff threshold), and implement a second restoration process different from the first restoration process for a second monitored parameter exceeding a second threshold (e.g., a monitored pilot signal power ratio exceeding a pilot signal power ratio threshold).

In one example, after implementing the restoration process to mitigate detected acoustic path interference of microphone 110-a, audio manager 130, in conjunction with audio processor 125, may be configured to capture a mitigated audio signal from microphone 110-a, while capturing audio signals from at least one of microphone 110-b, microphone 110-c, or microphone 110-d, or any combination thereof.

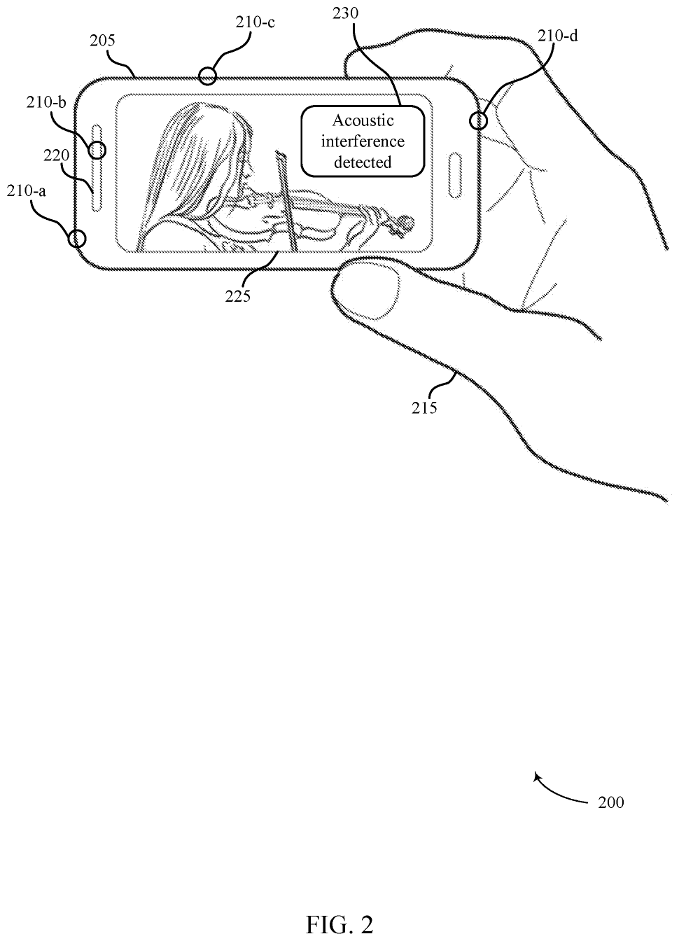

FIG. 2 illustrates an example of a system 200 that supports detection and restoration of distorted signals of one or more blocked microphones in accordance with aspects of the present disclosure. In some examples, system 200 may implement aspects of system 100.

In the illustrated example, system 200 includes a device 205 As shown, device 205 may include multiple microphones. In the illustrated example, device 205 may include microphone 210-a, microphone 210-b, microphone 210-c, microphone 210-d, speaker 220, and screen 225. Device 205 may be an example of device 105 of system 100 (e.g., device 205 may include an audio manager or audio processor, or both, connected to microphones 210). In some examples, device 205 may be configured to record audio, photos, or video. Device 205 capturing video may include device 205 capturing audio while capturing multiple images at a certain frame rate (e.g. 15 frames per second (fps), 24 fps, 25, fps, 29.97 fps, 30 fps, etc.). In some examples, device 205 may capture audio, via at least one of microphones 210, in conjunction with capturing one or more photos.

In some examples, an object (e.g., wall, chair, table, etc.) or part of hand 215 (e.g., finger, palm, back of hand, etc.) may be adjacent to at least one of microphones 210. For example, an object or part of hand 215 may cover at least one of microphones 210, obstructing one or more acoustic paths between a sound source and the at least one covered microphone 210.

In the illustrated example, device 205 captures video while device 205 is held by or near a hand 215. In the illustrated example, device 205 captures video images via at least one camera on device 205 while microphones 210 capture accompanying audio. In the illustrated example, a camera of device 205 captures video images of a violinist while microphones 210 capture the audio of the violinist. In the example, microphone 210-d and at least one other microphone 210 capture the audio of the violinist. As shown, a part of hand 215 is covers or blocks microphone 210-d. In one example, device 205 may detect an acoustic path interference before or during audio recording (e.g., ambisonic capture) of microphone 210-d based on a part of hand 215 being adjacent to or covering microphone 210-d.

In some examples, the acoustic path interference of microphone 210-d may distort the signal gain or frequency coloration, or both, of the audio signals recorded by microphone 210-d. Conversely, in the illustrated example microphone 210-a, microphone 210-b, and microphone 210-c may be unobstructed. Accordingly, device 205 may determine that interference exists in the acoustic path between the violinist and microphone 210-d, while no interference exists in the acoustic path between the violinist and microphone 210-a, microphone 210-b, and microphone 210-c.

When device 205 determines microphone 210-d is affected by acoustic path interference, device 205 may implement a restoration process to minimize or eliminate distortion on the audio signal of microphone 210-d caused by the acoustic path interference. In some examples, device 205 may generate one or more notifications based on device 205 determining microphone 210-d is affected by acoustic path interference. As shown, device 205 may display notification 230 on screen 225. As shown, notification 230 may include a message that indicates acoustic path interference is detected. In some examples, notification 230 may indicate that a restoration process has been automatically implemented by the device upon detecting the acoustic path interference. In some examples, notification 230 may include a graphical button and a query that asks whether the restoration process should be implemented to mitigate the acoustic path interference.

In some examples, the restoration process may include a gain restoration. For example, device 205 may restore a distorted gain associated with the acoustic path interference of microphone 210-d. In some examples, the restoration process may include a frequency coloration restoration. For example, device 205 may restore a distorted frequency coloration associated with the acoustic path interference of microphone 210-d. In some examples,

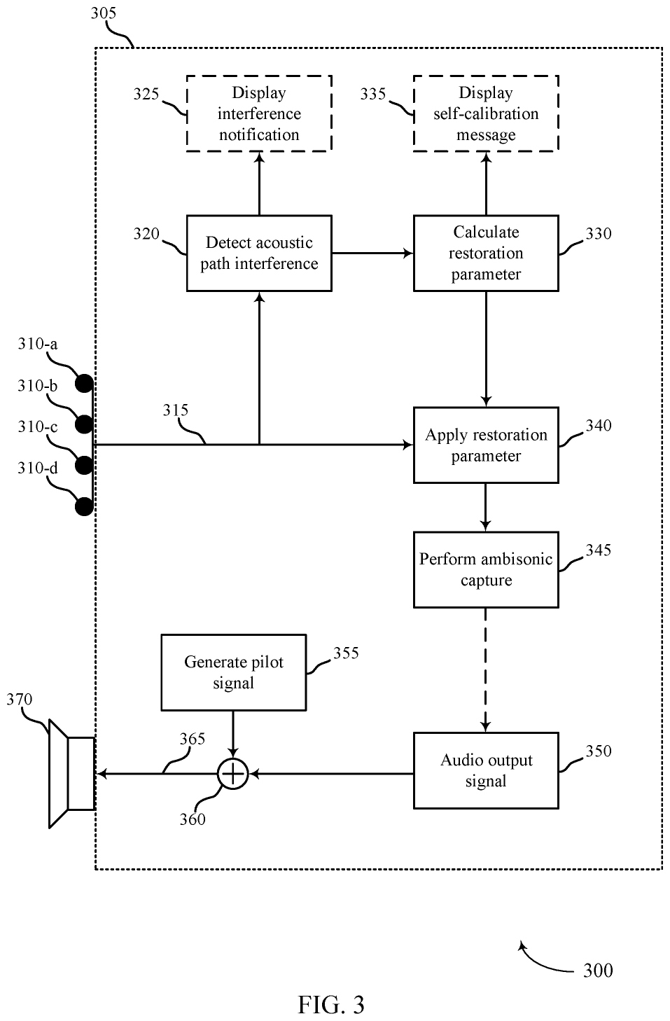

FIG. 3 illustrates an example of a system 300 that supports detection and restoration of distorted signals of one or more blocked microphones in accordance with aspects of the present disclosure. In some examples, system 300 may implement aspects of system 100.

In the illustrated example, system 300 includes a device 305, which may be an example of device 205 or device 105 as described herein. As shown, device 305 may include microphones 310 and speaker 370. In some examples, device 305 may include one or more processors (e.g., one or more audio processors). In some examples, one or more operations described in relation to FIG. 3 may be performed in conjunction with at least one of the one or more processors.

In the illustrated example, microphones 310 may be configured to record ambisonic capture. In some examples, device 305 may receive audio signal 315 from microphones 310. In some examples, audio signal 315 may include an audio signal from each of microphones 310. For example, audio signal 315 may include a first audio signal from microphone 310-a, a second audio signal from microphone 310-b, a third audio signal from microphone 310-c, and a fourth audio signal from microphone 310-d. In some examples, device 305 may analyze audio signal 315 to determine whether an acoustic path interference exists in audio signal 315. In some examples, device 305 may monitor one or more parameters in audio signal 315 to determine whether at least one of the monitored parameters exceeds a threshold.

At 320, device 305 may detect an acoustic path interference in audio signal 315. For example, device 305 may determine at least one of the monitored parameters exceeds a threshold based on monitoring. At 325, device 305 may optionally display an interference notification on a screen of device 305 based on detecting the acoustic path interference at 320.

In some examples, device 305 may detect the acoustic path interference when the power ratio of a low frequency component exceeds a threshold. In some examples, a physical interference in an acoustic path between a sound source and one or more affected microphones 310 may result in a low frequency component in the audio signal of the affected microphone 310 cutting out or dropping off. Accordingly, device 305 may detect an acoustic path of the affected microphone 310 experiencing the interference based on device 305 detecting when a low frequency signal disappears from the audio signal of affected microphone 310.

For example, based on the monitoring of audio signal 315, device 305 may detect a low frequency component in an audio signal generated by microphone 310-a at a first time period and later at a second time period detect the absence of the previously detected low frequency signal. In one example, device 305 may compare a low frequency power measured from microphone 310-a (p1) to a low frequency power from microphone 310-b (p2). In some examples, device 305 may analyze a ratio of the measured low frequency power levels p1 and p2 (e.g., p2/p1 or p1/p2). When the audio signal of microphone 310-a experiences interference, the measured low frequency power may drop. Accordingly, the low frequency power ratio p2/p1 would increase as the measured low frequency power of microphone 310-a drops.

In some examples, device 305 may determine a p2/p1 low frequency power ratio threshold in a calibration process, determining at least one of an expected range for p1, an expected range for p2, or an expected range for p2/p1, or any combination thereof. When device 305 detects the low frequency power ratio p2/p1 exceeding a threshold (e.g., a p2/p1 low frequency power ratio threshold determined during the calibration process), device 305 may determine microphone 310-a is experiencing interference.

In some examples, device 305 may detect the acoustic path interference when the power ratio of a pilot signal exceeds a threshold. In some examples, a non-audible pilot signal (e.g., a pilot signal less than 20 Hz or greater than 20 kHz) may be inserted in playback of an audio signal. In some examples, device 305 may detect the interference when the power ratio of pilot tone signal exceeds a threshold.

For example, device 305 may determine whether an inserted pilot signal is missing from an audio signal of an affected microphone 310. At 350, device 305 may provide an audio output signal to an adder 360. At 355, device 350 may generate a pilot signal. As shown, adder 360 may add the generated pilot signal to the audio output signal of 350 to generate the modified output signal 365. In some examples, device 305 may measure the modified output signal 365.

In some examples, device 305 may provide the modified output signal 365 to speaker 370, which output from speaker 370 may be captured by microphones 310 as a feedback loop to assist device 305 in detecting interference. In some examples, the audio output signal of 350 may optionally be based on audio from an ambisonic capture at 345. In one example, device 305 may compare a pilot signal power measured from microphone 310-a (ps1) to a pilot signal power from microphone 310-b (ps2). In some examples, device 305 may analyze a ratio of the measure pilot signal power levels ps1 and ps2 (e.g., ps2/ps1 or ps1/ps2).

When the audio signal of microphone 310-a experiences interference, the measured pilot signal power may drop. Accordingly, the pilot signal power ratio ps2/ps1 would increase as the measured pilot signal power of microphone 310-a drops. In some examples, device 305 may determine a ps2/ps1 pilot signal power ratio threshold in a calibration process, determining at least one of an expected range for ps1, an expected range for ps2, or an expected range for ps2/ps1, or any combination thereof. When device 305 detects the pilot signal power ratio ps2/ps1 exceeding a threshold (e.g., a ps2/ps1 pilot signal power ratio threshold determined during the calibration process), device 305 may determine microphone 310-a is experiencing interference.

In some examples, device 305 may detect the acoustic path interference based on device 305 detecting a distortion to a frequency coloration in audio signal 315. Frequency coloration may refer to an audio signature of a particular sound system. The original source of a sound (e.g., human voice, instrument) generates the sound in its pure original state. When a pure sound passes through an audio component (e.g., microphone, speaker, amplifier, audio processor) the passing through is said to “color” the pure original sound. In some examples, the passing of the original sound through an audio component may add overtones, undertones, and resonances to the pure sound. For example, added resonances that “color” the pure sound may add extraneous information, which is the audio signature added to the pure original sound by passing the pure original sound through the audio component.

In some examples, the coloration of an audio component of device 305 (e.g., microphones 310, speaker 370) may be calibrated for a certain audio signature. In some examples, an undistorted audio signal may be characterized by capturing the undistorted audio signal by at least one microphone 310 of device 305 to identify an undistorted frequency coloration of the captured audio. For example, a sample of a human voice may be analyzed after passing through microphones 310 or speaker 370, or both. Based on the analysis, the coloration of the microphones 310 and speaker 370 may be calibrated. In some examples, desired colorations of microphones 310 and speaker 370 may be stored on device 305 during a calibration process.

At 330, device 305 may calculate a restoration parameter. In some examples, calculating the restoration parameter may include calculating a restoration gain. In some examples, device 305 may calculate a restoration gain for an audio signal of a microphone 310 experiencing interference based on the calculated low frequency power ratio or calculated pilot signal power ratio associated with the affected microphone 310. For example, when device 305 determines the low frequency power ratio indicates the low frequency power level of an audio signal from microphone 310-a has dropped a first amount (e.g., 20%), then device 305 may increase the gain of microphone 310-a by a second amount (e.g., 20%), which may be more then, equal to, or less than the first amount. Similarly, when device 305 determines that the pilot signal power ratio indicates the pilot signal power level of an audio signal from microphone 310-d has dropped by a first amount (e.g., 30%), then device 305 may increase the gain of microphone 310-d by a second amount (e.g., 30%), which may be more then, equal to, or less than the first amount.

In some examples, device 305 calculating the restoration parameter may include device 305 calculating a frequency coloration restoration. In some examples, distorted colorations may be restored to a desired coloration by device 305 designing and generating an inverse filter based on the distorted coloration, and applying the inverse filter to the distorted signal to restore the desired frequency coloration. In one example, device 305 may detect a distorted frequency coloration in an audio signal of microphone 310-c and as a result may generate and apply an inverse filter to the audio signal of the microphone 310-c to mitigate the distorted frequency coloration.

In some examples, calculating the restoration parameter may include calculating a coefficient of a digital filter or calculating a modification to a coefficient of the digital filter. In some examples, a processor of device 305 may include a digital signal processor (DSP) configured to process digital samples of audio captured by microphones 310. For example, audio signal 315 may include one or more audio samples. In some examples, an audio sample may include one or more values. In some examples, device 305 may apply a filter to the audio sample. In some examples, the filter may include a digital filter. In some examples, the digital filter may include one or more coefficients (e.g., similar to resistors and capacitors used in analog filters). In some examples, a frequency response of the captured audio may be determined by the coefficients of the digital filter. In one example, device 305 may perform an operation on the value of the audio sample based on the coefficients of the digital filter (e.g., multiply the value of the sample audio by a coefficient, add a coefficient to the value of the sample audio, subtract a coefficient from the value of the sample audio, subtract the value of the sample audio from the coefficient, and so on). At 335, device 305 may optionally display a self-calibration message indicating device 305 is implementing a restoration process to mitigate the detected audio path interference.

At 340, device 305 may apply the restoration parameter to the audio signal of the microphone 310 affected by the acoustic path interference device 305 detects at 320. In some examples, applying the restoration parameter may include device 305 switching or modifying filter coefficients applied to an audio signal of the affected microphone 310. In one example, device 305 may determine microphone 310-a is experiencing acoustic path interference. In the example, switching of modifying filter coefficients applied to an audio signal of the affected microphone 310-a may include amplifying the audio signal of microphone 310-a (e.g., increasing the gain of the audio signal of microphone 310-a), suppressing the audio signal of microphone 310-a (e.g., decreasing the gain of the audio signal of microphone 310-a), or amplifying the audio signals of the unaffected microphones 310-b, 310-c, and 310-d, or a combination thereof.

In some examples, device 305 applying the restoration parameter may include device 305 switching from a first calibration configuration tuned to be used with the audio signals of microphone 310-a to a second calibration configuration tuned to be used without the audio signal of microphone 310-a. For example, the first calibration configuration may be tuned to be used with the audio signals of microphone 310-a, microphone 310-b, microphone 310-c, and microphone 310-d, while the second calibration configuration may be tuned to be used with microphone 310-b, microphone 310-c, and microphone 310-d (without microphone 310-a), ignoring (e.g., not accounting for) or discarding the audio signal of at least one other microphone, such as microphone 310-a. In some cases, the first calibration configuration may be tuned to be used with the audio signals of a first set of microphones that include microphone 310-a (e.g., microphone 310-a, microphone 310-c, and microphone 310-d), while the second calibration configuration may be tuned to be used with the audio signals of a second set of microphones that uses another microphone or is limited to a subset of the first of microphones in place of microphone 310-a (e.g., microphone 310-b, microphone 310-c, and microphone 310-d). For example, device 305 may implement the first calibration configuration (e.g., ambisonic capture using microphone 310-a, microphone 310-c, and microphone 310-d) until device 305 determines microphone 310-a is experiencing acoustic path interference. Device 305 may then switch to the second calibration configuration (e.g., ambisonic capture using microphone 310-b, microphone 310-c, and microphone 310-d) to mitigate the acoustic path interference of microphone 310-a, using microphone 310-b in place of microphone 310-a.

At 345, device 305 may perform ambisonic capture based on based at least in part on device 305 implementing a restoration process to mitigate acoustic path interference device 305 detects at 320. For example, device 305 may perform ambisonic capture based on device 305 applying the restoration parameter at 340.

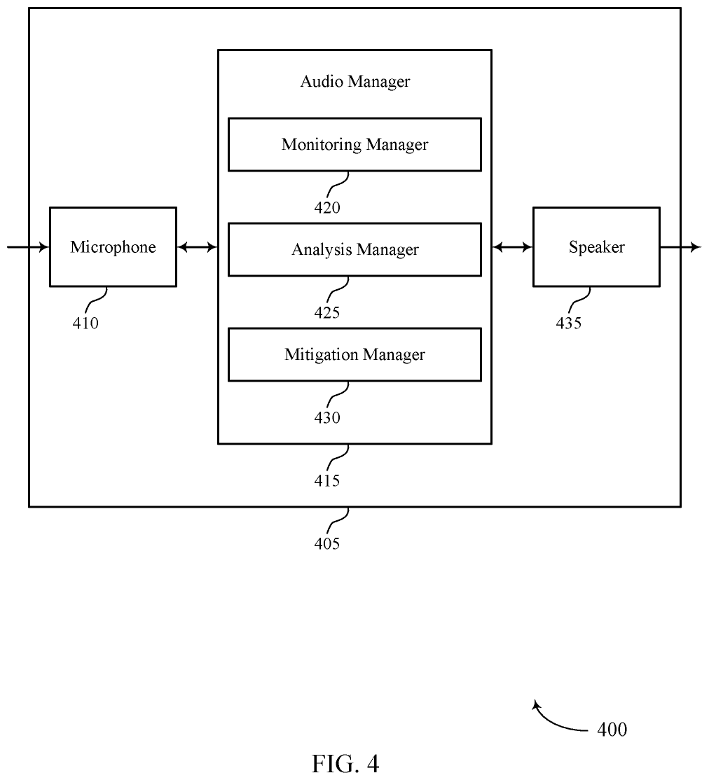

FIG. 4 shows a block diagram 400 of a device 405 that supports detection and restoration of distorted signals of one or more blocked microphones in accordance with aspects of the present disclosure. The device 405 may be an example of aspects of a device 105, device 205, or device 305 as described herein. The device 405 may include microphones 410, an audio manager 415, and one or more speakers 435. The device 405 may also include one or more processors. Each of these components may be in communication with one another (e.g., via one or more buses).

Microphones 410 may be or represent components of device 405 used to receive information (e.g., audio signals, data packets, etc.). Generally, microphones 410 may represent transducers for converting sound (e.g., or another physical signal) into an electrical signal (e.g., for processing by audio manager 415). In accordance with the described techniques, device 405 may include multiple microphones 410 arranged according to a given pattern (e.g., which pattern may inform or influence a directional signal processing capability of device 405 as described with reference to audio manager 415). Information may be passed from microphones 410 to other components of the device 405.

The audio manager 415 may be an example of aspects of the audio manager 130 as described herein. The audio manager 415 may include a monitoring manager 420, an analysis manager 425, and a mitigation manager 430. The audio manager 415 may be an example of aspects of the audio manager 610 described herein. In some examples, audio manager 415, or its subcomponents, may perform one or more operation in conjunction with at last one processor (e.g., audio processor 125). In some examples, audio manager 415 may include one or more processors. The audio manager 415, or its sub-components, may be implemented in hardware, code (e.g., software or firmware) executed by a processor, or any combination thereof. For those functions implemented in code executed by a processor, the functions of the audio manager 415, or its sub-components, may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure. The one or more processors associated with audio manager 415, or its sub-components, may be physically located at various positions, including being distributed such that portions of functions are implemented at different physical locations by one or more physical components. In some examples, the one or more processors associated with the audio manager 415, or its sub-components, may be a separate and distinct component in accordance with various aspects of the present disclosure. In some examples, the one or more processors associated with audio manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The monitoring manager 420 may monitor a parameter associated with an audio signal received by at least a first microphone of microphones 410. The analysis manager 425 may determine that the monitored parameter associated with the audio signal exceeds a threshold by comparing the monitored parameter to the threshold and determine an acoustic path interference associated with the monitored parameter based on the monitored parameter exceeding the threshold, the acoustic path interference including a physical interference in an acoustic path to at least the first microphone. The mitigation manager 430 may implement a restoration process to mitigate the acoustic path interference based on determining the acoustic path interference associated with the monitored parameter.

The speaker 435 may represent a transducer for converting an electrical signal to a sound. Speaker 435 may in some cases output an audio signal representing sound received at the set of microphones 410. In some examples, speaker 435 may output an audio signal that includes a pilot tone signal. In some examples, microphones 410 may capture audio outputted by speaker 435.

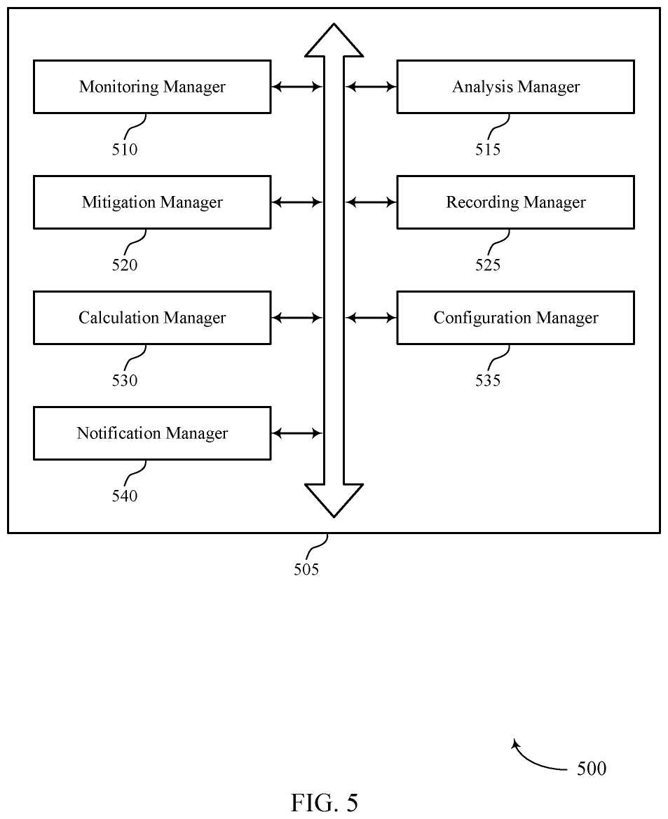

FIG. 5 shows a block diagram 500 of an audio manager 505 that supports detection and restoration of distorted signals of one or more blocked microphones in accordance with aspects of the present disclosure. The audio manager 505 may be an example of aspects of an audio manager 130, an audio manager 415, or an audio manager 610 described herein. The audio manager 505 may include a monitoring manager 510, an analysis manager 515, a mitigation manager 520, a recording manager 525, a calculation manager 530, a configuration manager 535, and a notification manager 540. Each of these modules may communicate, directly or indirectly, with one another (e.g., via one or more buses).

The monitoring manager 510 may monitor a parameter associated with an audio signal received by at least a first microphone of multiple microphones of a device. In some examples, the monitored parameter includes an energy ratio, a frequency rolloff, an impulse response, or a transfer function, or any combination thereof.

The analysis manager 515 may determine that the monitored parameter associated with the audio signal exceeds a threshold by comparing the monitored parameter to the threshold. In some examples, the analysis manager 515 may determine an acoustic path interference associated with the monitored parameter based on the monitored parameter exceeding the threshold, the acoustic path interference including a physical interference in an acoustic path to at least the first microphone.

In some examples, the analysis manager 515 may determine that a frequency power ratio associated with the audio signal exceeds a frequency threshold. In some examples, the analysis manager 515 may determine that a pilot signal power ratio associated with the audio signal exceeds a pilot signal threshold.

In some examples, the analysis manager 515 may detect a distorted frequency coloration in the audio signal of the first microphone based on determining the acoustic path interference, where implementing the restoration process is based on mitigating the distorted frequency coloration. In some examples, the analysis manager 515 may generate one or more inverse filters based on comparing the distorted frequency coloration and the calibrated frequency coloration.

The mitigation manager 520 may implement a restoration process to mitigate the acoustic path interference based on determining the acoustic path interference associated with the monitored parameter. In some examples, the mitigation manager 520 may apply the restoration gain to the audio signal, or suppressing the audio signal and applying the restoration gain to an audio signal of a second microphone of the multiple microphones to mitigate the acoustic path interference, where the frequency power ratio is a ratio between measured power levels of the audio signal of the first microphone and measured power levels of an audio signal of a second microphone of the multiple microphones.

In some examples, the mitigation manager 520 may apply the restoration gain to the audio signal, suppressing the audio signal and applying the restoration gain to an audio signal of a second microphone of the multiple microphones to mitigate the acoustic path interference, where the pilot signal power ratio is a ratio between measured power levels of the audio signal of the first microphone and measured power levels of an audio signal of a second microphone of the multiple microphones. In some examples, the mitigation manager 520 may apply the one or more inverse filters to the audio signal of the first microphone to mitigate the distorted frequency coloration.

In some examples, the mitigation manager 520 may receive a user input to initiate the restoration process in response to the request, where implementing the restoration process is based on the user input. In some examples, the mitigation manager 520 may initiate the restoration process automatically based on determining the acoustic path interference associated with the monitored parameter.

The recording manager 525 may capture, as part of an ambisonic audio capture based on implementing the restoration process, the audio signal from the first microphone and at least an audio signal of a second microphone from the multiple microphones.

The calculation manager 530 may calculate a restoration gain based on a variation between the frequency power ratio and a second frequency power ratio that is defined during a calibration process, where the restoration process is based on the restoration gain. In some examples, the calculation manager 530 may calculate a restoration gain based on a variation between the pilot signal power ratio and a pilot signal power ratio that is defined during a calibration process, where the restoration process is based on the restoration gain.

The configuration manager 535 may switch from a first calibration configuration to a second calibration configuration, where the first calibration configuration is tuned to be used with the audio signal of the first microphone and an audio signal from a second microphone from the multiple microphones, and where the second calibration configuration is tuned to be used with one of the audio signal of the second microphone or the audio signal of the first microphone. In some examples, the configuration manager 535 may determine a calibrated frequency coloration associated with the first microphone during a calibration process.

The notification manager 540 may generate a notification for a user regarding the determined acoustic path interference, where the notification includes a request that a user of the device initiate the restoration process or a message that the restoration process is being implemented automatically. In some examples, the notification manager 540 may display the notification on a display of the device.

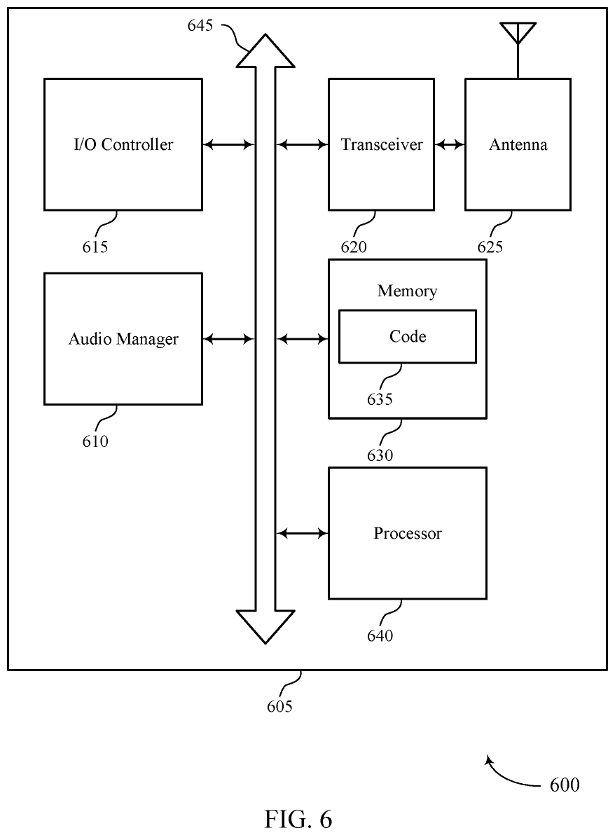

FIG. 6 shows a diagram of a system 600 including a device 605 that supports detection and restoration of distorted signals of one or more blocked microphones in accordance with aspects of the present disclosure. The device 605 may be an example of or include the components of device 105, device 205, device 305, device 405, or a device as described herein. The device 605 may include components for bi-directional voice and data communications including components for transmitting and receiving communications, including an audio manager 610, an I/O controller 615, a transceiver 620, an antenna 625, memory 630, and a processor 640. These components may be in electronic communication via one or more buses (e.g., bus 645).

The audio manager 610 may monitor a parameter associated with an audio signal received by at least a first microphone of multiple microphones of a device, determine that the monitored parameter associated with the audio signal exceeds a threshold by comparing the monitored parameter to the threshold, determine an acoustic path interference associated with the monitored parameter based on the monitored parameter exceeding the threshold, the acoustic path interference including a physical interference in an acoustic path to at least the first microphone, and implement a restoration process to mitigate the acoustic path interference based on determining the acoustic path interference associated with the monitored parameter.

The I/O controller 615 may manage input and output signals for the device 605. The I/O controller 615 may also manage peripherals not integrated into the device 605. In some examples, the I/O controller 615 may represent a physical connection or port to an external peripheral. In some examples, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some examples, the I/O controller 615 may be implemented as part of a processor. In some examples, a user may interact with the device 605 via the I/O controller 615 or via hardware components controlled by the I/O controller 615.

The transceiver 620 may communicate bi-directionally, via one or more antennas, wired, or wireless links as described above. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas.

In some examples, the wireless device may include a single antenna 625. However, in some cases the device may have more than one antenna 625, which may be capable of concurrently transmitting or receiving multiple wireless transmissions.

The memory 630 may include RAM and ROM. The memory 630 may store computer-readable, computer-executable code 635 including instructions that, when executed, cause the processor to perform various functions described herein. In some examples, the memory 630 may contain, among other things, a BIOS which may control basic hardware or software operation such as the interaction with peripheral components or devices.

The processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some examples, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks supporting detection and restoration of distorted signals of one or more blocked microphones).

The code 635 may include instructions to implement aspects of the present disclosure, including instructions to support mitigating audio interference. The code 635 may be stored in a non-transitory computer-readable medium such as system memory or other type of memory. In some examples, the code 635 may not be directly executable by the processor 640 but may cause a computer (e.g., when compiled and executed) to perform functions described herein.

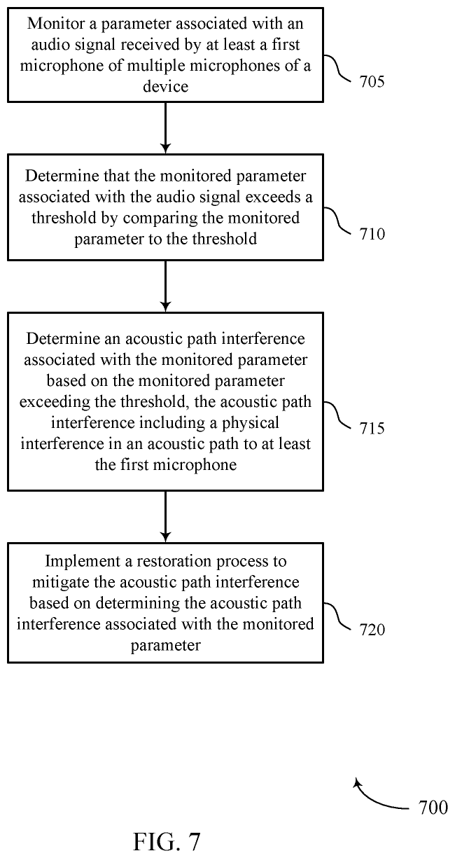

FIG. 7 shows a flowchart illustrating a method 700 that supports detection and restoration of distorted signals of one or more blocked microphones in accordance with aspects of the present disclosure. The operations of method 700 may be implemented by a device or its components as described herein. For example, the operations of method 700 may be performed by an audio manager as described with reference to FIGS. 1 through 6. In some examples, a device may execute a set of instructions to control the functional elements of the device to perform the functions described below. Additionally or alternatively, a device may perform aspects of the functions described below using special-purpose hardware.

At 705, the device may monitor a parameter associated with an audio signal received by at least a first microphone of multiple microphones of a device. The operations of 705 may be performed according to the methods described herein. In some examples, aspects of the operations of 705 may be performed by a monitoring manager as described with reference to FIGS. 1 through 6.

At 710, the device may determine that the monitored parameter associated with the audio signal exceeds a threshold by comparing the monitored parameter to the threshold. The operations of 710 may be performed according to the methods described herein. In some examples, aspects of the operations of 710 may be performed by an analysis manager as described with reference to FIGS. 1 through 6.

At 715, the device may determine an acoustic path interference associated with the monitored parameter based on the monitored parameter exceeding the threshold, the acoustic path interference including a physical interference in an acoustic path to at least the first microphone. The operations of 715 may be performed according to the methods described herein. In some examples, aspects of the operations of 715 may be performed by an analysis manager as described with reference to FIGS. 1 through 6.

At 720, the device may implement a restoration process to mitigate the acoustic path interference based on determining the acoustic path interference associated with the monitored parameter. The operations of 720 may be performed according to the methods described herein. In some examples, aspects of the operations of 720 may be performed by a mitigation manager as described with reference to FIGS. 1 through 6.

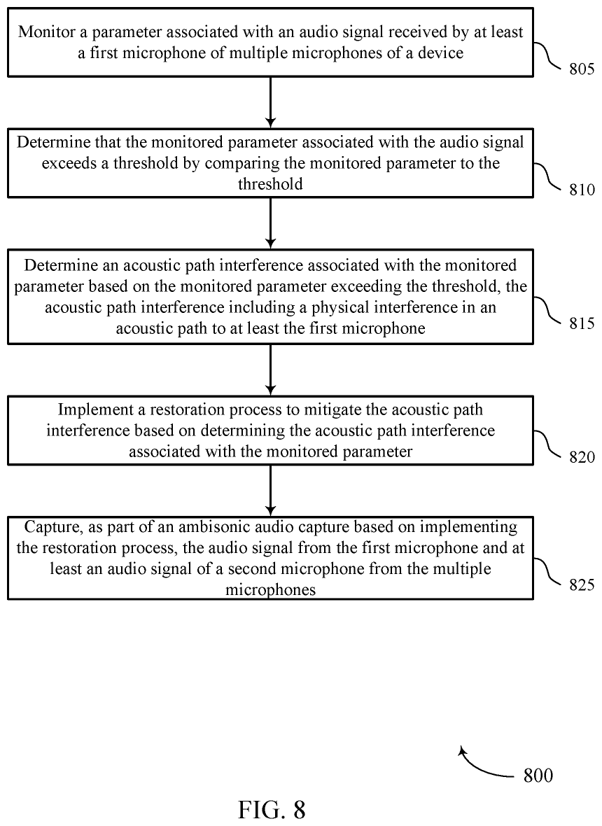

FIG. 8 shows a flowchart illustrating a method 800 that supports detection and restoration of distorted signals of one or more blocked microphones in accordance with aspects of the present disclosure. The operations of method 800 may be implemented by a device or its components as described herein. For example, the operations of method 800 may be performed by an audio manager as described with reference to FIGS. 1 through 6. In some examples, a device may execute a set of instructions to control the functional elements of the device to perform the functions described below. Additionally or alternatively, a device may perform aspects of the functions described below using special-purpose hardware.

At 805, the device may monitor a parameter associated with an audio signal received by at least a first microphone of multiple microphones of a device. The operations of 805 may be performed according to the methods described herein. In some examples, aspects of the operations of 805 may be performed by a monitoring manager as described with reference to FIGS. 1 through 6.

At 810, the device may determine that the monitored parameter associated with the audio signal exceeds a threshold by comparing the monitored parameter to the threshold. The operations of 810 may be performed according to the methods described herein. In some examples, aspects of the operations of 810 may be performed by an analysis manager as described with reference to FIGS. 1 through 6.

At 815, the device may determine an acoustic path interference associated with the monitored parameter based on the monitored parameter exceeding the threshold, the acoustic path interference including a physical interference in an acoustic path to at least the first microphone. The operations of 815 may be performed according to the methods described herein. In some examples, aspects of the operations of 815 may be performed by an analysis manager as described with reference to FIGS. 1 through 6.

At 820, the device may implement a restoration process to mitigate the acoustic path interference based on determining the acoustic path interference associated with the monitored parameter. The operations of 820 may be performed according to the methods described herein. In some examples, aspects of the operations of 820 may be performed by a mitigation manager as described with reference to FIGS. 1 through 6.

At 825, the device may capture, as part of an ambisonic audio capture based on implementing the restoration process, the audio signal from the first microphone and at least an audio signal of a second microphone from the multiple microphones. The operations of 825 may be performed according to the methods described herein. In some examples, aspects of the operations of 825 may be performed by a recording manager as described with reference to FIGS. 1 through 6.

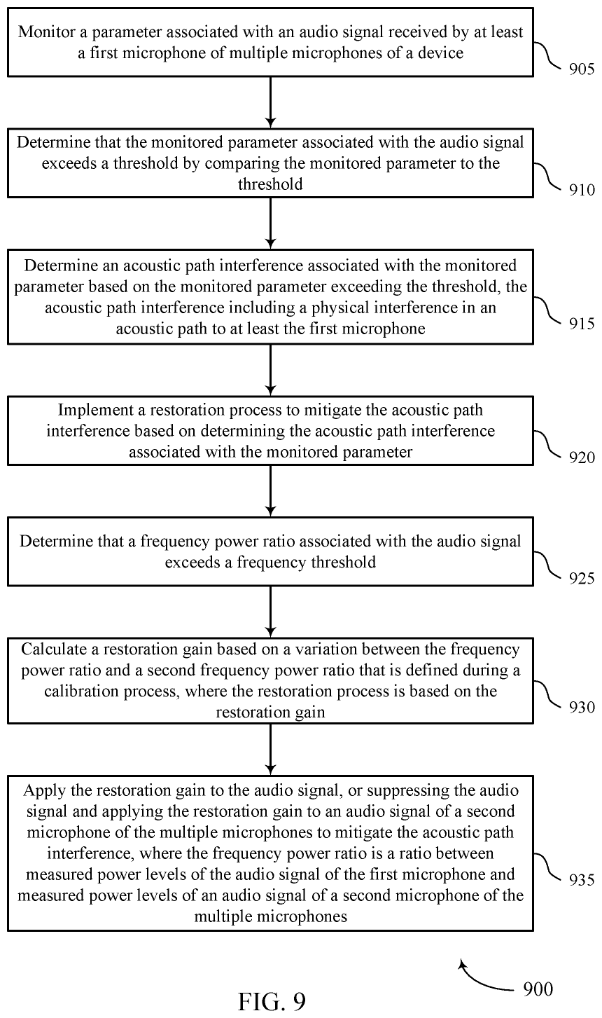

FIG. 9 shows a flowchart illustrating a method 900 that supports detection and restoration of distorted signals of one or more blocked microphones in accordance with aspects of the present disclosure. The operations of method 900 may be implemented by a device or its components as described herein. For example, the operations of method 900 may be performed by an audio manager as described with reference to FIGS. 1 through 6. In some examples, a device may execute a set of instructions to control the functional elements of the device to perform the functions described below. Additionally or alternatively, a device may perform aspects of the functions described below using special-purpose hardware.

At 905, the device may monitor a parameter associated with an audio signal received by at least a first microphone of multiple microphones of a device. The operations of 905 may be performed according to the methods described herein. In some examples, aspects of the operations of 905 may be performed by a monitoring manager as described with reference to FIGS. 1 through 6.

At 910, the device may determine that the monitored parameter associated with the audio signal exceeds a threshold by comparing the monitored parameter to the threshold. The operations of 910 may be performed according to the methods described herein. In some examples, aspects of the operations of 910 may be performed by an analysis manager as described with reference to FIGS. 1 through 6.

At 915, the device may determine an acoustic path interference associated with the monitored parameter based on the monitored parameter exceeding the threshold, the acoustic path interference including a physical interference in an acoustic path to at least the first microphone. The operations of 915 may be performed according to the methods described herein. In some examples, aspects of the operations of 915 may be performed by an analysis manager as described with reference to FIGS. 1 through 6.

At 920, the device may implement a restoration process to mitigate the acoustic path interference based on determining the acoustic path interference associated with the monitored parameter. The operations of 920 may be performed according to the methods described herein. In some examples, aspects of the operations of 920 may be performed by a mitigation manager as described with reference to FIGS. 1 through 6.

At 925, the device may determine that a frequency power ratio associated with the audio signal exceeds a frequency threshold. The operations of 925 may be performed according to the methods described herein. In some examples, aspects of the operations of 925 may be performed by an analysis manager as described with reference to FIGS. 1 through 6.

At 930, the device may calculate a restoration gain based on a variation between the frequency power ratio and a second frequency power ratio that is defined during a calibration process, where the restoration process is based on the restoration gain. The operations of 930 may be performed according to the methods described herein. In some examples, aspects of the operations of 930 may be performed by a calculation manager as described with reference to FIGS. 1 through 6.

At 935, the device may apply the restoration gain to the audio signal, or suppressing the audio signal and applying the restoration gain to an audio signal of a second microphone of the multiple microphones to mitigate the acoustic path interference, where the frequency power ratio is a ratio between measured power levels of the audio signal of the first microphone and measured power levels of an audio signal of a second microphone of the multiple microphones. The operations of 935 may be performed according to the methods described herein. In some examples, aspects of the operations of 935 may be performed by a mitigation manager as described with reference to FIGS. 1 through 6.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for mitigating audio interference, comprising:
monitoring a parameter associated with an audio signal received by at least a first microphone of multiple microphones of a device;
determining that the monitored parameter associated with the audio signal exceeds a threshold by comparing the monitored parameter to the threshold;
determining an acoustic path interference associated with the monitored parameter based at least in part on the monitored parameter exceeding the threshold, the acoustic path interference comprising a physical interference in an acoustic path to at least the first microphone; and
implementing a restoration process to mitigate the acoustic path interference based at least in part on determining the acoustic path interference associated with the monitored parameter.

2. The method of claim 1, further comprising:
capturing, as part of an ambisonic audio capture based at least in part on implementing the restoration process, the audio signal from the first microphone and at least an audio signal of a second microphone from the multiple microphones.

3. The method of claim 1, wherein determining that the monitored parameter associated with the audio signal exceeds the threshold comprises:
determining that a frequency power ratio associated with the audio signal exceeds a frequency threshold.

4. The method of claim 3, further comprising:
calculating a restoration gain based at least in part on a variation between the frequency power ratio and a second frequency power ratio that is defined during a calibration process, wherein the restoration process is based at least in part on the restoration gain.

5. The method of claim 4, wherein implementing the restoration process comprises:
applying the restoration gain to the audio signal, or suppressing the audio signal and applying the restoration gain to an audio signal of a second microphone of the multiple microphones to mitigate the acoustic path interference, wherein the frequency power ratio is a ratio between measured power levels of the audio signal of the first microphone and measured power levels of an audio signal of a second microphone of the multiple microphones.

6. The method of claim 1, wherein determining that the monitored parameter associated with the audio signal exceeds the threshold comprises:
determining that a pilot signal power ratio associated with the audio signal exceeds a pilot signal threshold.

7. The method of claim 6, further comprising:
calculating a restoration gain based at least in part on a variation between the pilot signal power ratio and a pilot signal power ratio that is defined during a calibration process, wherein the restoration process is based at least in part on the restoration gain.

8. The method of claim 7, wherein implementing the restoration process comprises:
applying the restoration gain to the audio signal, suppressing the audio signal and applying the restoration gain to an audio signal of a second microphone of the multiple microphones to mitigate the acoustic path interference, wherein the pilot signal power ratio is a ratio between measured power levels of the audio signal of the first microphone and measured power levels of an audio signal of a second microphone of the multiple microphones.

9. The method of claim 1, wherein implementing the restoration process comprises:
switching from a first calibration configuration to a second calibration configuration, wherein the first calibration configuration is tuned to be used with the audio signal of the first microphone and an audio signal from a second microphone from the multiple microphones, and wherein the second calibration configuration is tuned to be used with one of the audio signal of the second microphone or the audio signal of the first microphone.

10. The method of claim 1, further comprising:
determining a calibrated frequency coloration associated with the first microphone during a calibration process; and
detecting a distorted frequency coloration in the audio signal of the first microphone based at least in part on determining the acoustic path interference, wherein implementing the restoration process is based at least in part on mitigating the distorted frequency coloration.

11. The method of claim 10, wherein implementing the restoration process comprises:
generating one or more inverse filters based at least in part on comparing the distorted frequency coloration and the calibrated frequency coloration; and
applying the one or more inverse filters to the audio signal of the first microphone to mitigate the distorted frequency coloration.

12. The method of claim 1, wherein the monitored parameter comprises an energy ratio, a frequency rolloff, an impulse response, or a transfer function, or any combination thereof.

13. The method of claim 1, further comprising:
generating a notification for a user regarding the determined acoustic path interference, wherein the notification comprises a request that a user of the device initiate the restoration process or a message that the restoration process is being implemented automatically; and
displaying the notification on a display of the device.

14. The method of claim 13, further comprising:
receiving a user input to initiate the restoration process in response to the request, wherein implementing the restoration process is based at least in part on the user input.

15. The method of claim 1, wherein implementing the restoration process comprises:
initiating the restoration process automatically based at least in part on determining the acoustic path interference associated with the monitored parameter.

16. An apparatus for mitigating audio interference, comprising:
a processor,
memory coupled with the processor; and
instructions stored in the memory and executable by the processor to cause the apparatus to:
monitor a parameter associated with an audio signal received by at least a first microphone of multiple microphones of the apparatus;
determine that the monitored parameter associated with the audio signal exceeds a threshold by comparing the monitored parameter to the threshold;
determine an acoustic path interference associated with the monitored parameter based at least in part on the monitored parameter exceeding the threshold, the acoustic path interference comprising a physical interference in an acoustic path to at least the first microphone; and
implement a restoration process to mitigate the acoustic path interference based at least in part on determining the acoustic path interference associated with the monitored parameter.

17. The apparatus of claim 16, wherein the instructions are further executable by the processor to cause the apparatus to:
capture, as part of an ambisonic audio capture based at least in part on implementing the restoration process, the audio signal from the first microphone and at least an audio signal of a second microphone from the multiple microphones.

18. The apparatus of claim 16, wherein the instructions to determine that the monitored parameter associated with the audio signal exceeds the threshold are executable by the processor to cause the apparatus to:
determine that a frequency power ratio associated with the audio signal exceeds a frequency threshold.

19. A non-transitory computer-readable medium storing code for mitigating audio interference, the code comprising instructions executable by a processor of a device to:
monitor a parameter associated with an audio signal received by at least a first microphone of multiple microphones of the device;
determine that the monitored parameter associated with the audio signal exceeds a threshold by comparing the monitored parameter to the threshold;
determine an acoustic path interference associated with the monitored parameter based at least in part on the monitored parameter exceeding the threshold, the acoustic path interference comprising a physical interference in an acoustic path to at least the first microphone; and
implement a restoration process to mitigate the acoustic path interference based at least in part on determining the acoustic path interference associated with the monitored parameter.

20. The non-transitory computer-readable medium of claim 19, wherein the instructions are further executable to:
capture, as part of an ambisonic audio capture based at least in part on implementing the restoration process, the audio signal from the first microphone and at least an audio signal of a second microphone from the multiple microphones.
